(19) United States
(12) Patent Application Publication
(10) Pub. No.: US 2026/0131717 A1
(43) Pub. Date: May 14, 2026

(54) Track Spacer for Support System in Cargo Compartment

(71) Applicants: Prime Design Engineering Ltd, Bridgend (GB); Doleco USA, Inc., New Britain, CT (US)

(72) Inventor: Richard Jones, Bridgend (GB)

(73) Assignees: Prime Design Engineering Ltd, Bridgend (GB); Doleco USA, Inc., Meriden, CT (US)

(21) Appl. No.: 19/387,943

(22) Filed: Nov. 13, 2025

Related U.S. Application Data
(60) Provisional application No. 63/719,689, filed on Nov. 13, 2024.

(51) Int. Cl. B60P 7/08

(52) U.S. Cl. CPC B60P 7/0815

(57) ABSTRACT

A spacer for a track assembly in a cargo container includes a body extending along a linear axis and having a central recess configured to receive a track. The spacer is configured to be disposed between the track and a post of the cargo container. The spacer may include surfaces extending at angles relative to the post, effectively deflecting impact forces encountered during loading operations. The spacer includes recesses configured to receive adhesive tape for mounting to both the track and the post. A track assembly incorporating the spacer provides improved durability, simplified installation, and enhanced force distribution compared to traditional mounting configurations. The spacer maintains consistent performance across varying environmental conditions while accommodating different post configurations common in cargo containers.

### TECHNICAL FIELD

The present disclosure generally to the field of cargo control and more specifically to a system of adjustable load beams that provide decking to divide the cargo container into multiple levels of payload.

### BACKGROUND

In freight transportation, maximizing the utilization of available space within cargo containers is crucial for operational efficiency and cost-effectiveness. To achieve this, it is common practice to stack cargo in multiple levels, taking full advantage of the vertical space in cargo containers such as truck trailers, aircraft cargo holds, railroad cars, and other similar cargo enclosures. This multi-level stacking approach necessitates the use of robust and versatile decking systems.

At the heart of these decking systems are movable decking beams, designed to support substantial payload weights while offering flexibility in cargo arrangement. These beams are typically adjustable, allowing for repositioning at various heights and horizontal intervals within the cargo container. This adaptability is essential to accommodate the diverse sizes and shapes of cargo items transported across different industries.

A conventional cargo beam and decking system, as illustrated in FIG. 1, comprises several key components. The system includes a series of vertical mounting tracks 10 that line the walls along the length of the cargo container. These tracks feature a sequence of openings or slots, enabling the adjustment of decking beam heights to suit specific cargo requirements. In a typical configuration, multiple decking beams 20 span the width of the container, creating supportive platforms for upper layers of cargo pallets 30.

The adjustable decking beam itself, depicted in FIG. 2, consists of several parts working in concert. The beam 40 comprises a central hollow section 50, flanked by two adjustable end pieces 60, 70 that can slide within the beam's ends. Each of these end pieces terminates in a “foot” 65, 75 designed to engage with the vertical mounting tracks on the container walls. These feet incorporate trigger-operated locking mechanisms 80 that interface with the openings in the mounting tracks, allowing for secure positioning of the beams at desired heights.

The decking system described herein may be known by various names in the industry, including, but not limited to: load bars, E-track load bars, decking beams, logistic beams, cargo bars, captive decking, level loading system, multi-level loading system, freight loading system, E-track decking system, adjustable deck system, double-deck system, and freight bar system. Various manufacturers may utilize proprietary names for similar systems, such as Ancra Cargo Beam System, Kinedyne K2 Decking System, Whiting CommandGlide, and SafetyWeb Decking System. While these systems may be known by different names, they generally refer to the same fundamental concept of adjustable horizontal beams that create multiple loading levels within a trailer, though specific features, mechanisms, and implementations may vary between manufacturers and models.

While the decking system described herein is particularly useful in truck trailers, it should be understood that such systems may be implemented in various cargo-carrying spaces and vehicles, including, but not limited to: shipping containers, railway cars, cargo vans, delivery vehicles, storage facilities, warehouses, shipping vessels, aircraft cargo holds, intermodal containers, fixed storage units, portable storage units, and other enclosed or semi-enclosed spaces where efficient vertical space utilization and cargo organization is desired. The versatility of the decking system allows it to be adapted to various sizes and configurations of cargo spaces, providing similar benefits of improved load capacity, cargo protection, and efficient space utilization across different applications, while accommodating varying dimensional requirements and loading conditions specific to each type of cargo space.

In reference to FIGS. 4A and 4B, a portion or a decking system is shown. Namely, the system includes a track 16 that extends vertically in the cargo space when installed therein. The track 16 is configured for receiving the foot of the beam. In the embodiment shown, which is in accordance with the prior art, the track 16 is connected directly to the post 60. The post 60 is further connected to the panels 40 of the container. In the disclosed embodiment in FIG. 4A, the panels form an interior and exterior of the container. Together with the post 10, the panels 40 provide structural support for the trailer.

The track 10 extends along a linear axis from a first end to a second end. The track 10 includes a first groove 12 and a second groove 14 configured to receive corresponding elements of footing, such that footing and the associated beam can translate relative to the track along said axis and also be locked into position relative to said track thereby providing a support

The track 16 is connected to the post 60 using a plurality of rivets 18 that are spaced apart along the length of the track. Each rivet 18 extends through corresponding apertures in both the track 16 and the post 60, thereby securing the track directly against the surface of the post. This direct mounting configuration creates a connection between the track 16 and post 60, with the track surface being substantially flush against the post surface.

In some embodiments, washers are positioned between the track 16 and post 60. These washers must be manually positioned and held in place during installation, requiring additional time and labor. The number and positioning of the washers may vary depending on manufacturing tolerances and specific requirements for aligning the track relative to the post. This shimming process with washers, while functional, creates inefficiencies in the installation process and can lead to inconsistent spacing if not carefully executed.

This prior art configuration presents several disadvantages. The direct mounting of the track 16 to the post 60 leaves the track vulnerable to impacts and damage during loading and unloading operations. When the track is impacted, the force is transferred directly to both the track and the post structure. This is illustrated, for example, in FIGS. 3A and 3B. The installation process can be time-consuming, particularly in embodiments requiring washers for spacing and alignment. Furthermore, the rigid mounting provides limited ability to distribute impact forces, potentially concentrating stress at the connection points. These disadvantages can lead to increased maintenance requirements and potential downtime for repairs when damage occurs.

Given these persistent challenges, there remains a clear need in the industry for an improved track system and installation method for use with beam decking systems. Such a system should ideally combine the structural advantages of wide-top beams with enhanced durability, easier maintenance, and greater adaptability to varied cargo requirements. The present invention addresses these needs, offering a novel solution that promises to advance the state of the art in cargo container decking systems.

### SUMMARY OF THE INVENTION

The needs set forth herein as well as further and other needs and advantages are addressed by the present teachings, which illustrate solutions and advantages described below.

The present invention addresses longstanding needs in the cargo transportation industry by providing an improved track mounting system that enhances durability, simplifies installation, and improves operational performance.

In one aspect, the invention provides a spacer configured to be disposed between a track and a post in a cargo container. The spacer includes a body extending along a linear axis and having a central recess configured to receive the track. The spacer enables improved mounting of the track while providing protection against impacts during loading operations.

In another aspect, the invention provides a track assembly incorporating the spacer between the track and post. This configuration creates a more robust mounting system that better manages impact forces while simplifying installation procedures. The assembly may incorporate adhesive mounting that provides improved force distribution compared to traditional riveted installations.

The spacer may include angled sides that effectively deflect impact forces away from the track and post. These angled surfaces convert direct impacts into glancing blows, significantly reducing potential damage to the assembly. The specific angles may be optimized for particular applications while maintaining the deflective benefits.

The invention further provides for improved mounting through strategically placed recesses configured to receive adhesive tape. These recesses may be incorporated in the central recess of the spacer for securing the track, as well as on exterior surfaces for mounting to the post. This mounting system provides more uniform force distribution compared to traditional discrete mounting points.

Additional advantages of the invention include simplified installation procedures, improved thermal management, enhanced moisture control, and superior maintainability. The spacer design accommodates various post configurations while maintaining consistent performance characteristics.

These and other aspects of the present invention will become apparent through the detailed description and accompanying drawings provided herein.

### BRIEF DESCRIPTION OF THE DRAWINGS

FIG. 1 illustrates a cut-away perspective view of a truck trailer employing a cargo beam and decking system.

FIG. 2 is a side view of an adjustable decking beam.

FIG. 3A is a perspective view in an image of the inside of a trailer showing damaged tracks in a decking system.

FIG. 3B is a front view in an image of the inside of a trailer showing a damaged track in a decking system.

FIG. 4A illustrates a perspective view of a portion of a decking system in accordance with the prior art.

FIG. 4B illustrates an exploded cross-sectional view of the portion of the decking system shown in FIG. 4A.

FIG. 5A illustrates a cross-sectional view of a portion of a decking system in accordance with the present invention.

FIG. 5B illustrates an exploded cross-sectional view of the portion of the decking system shown in FIG. 5A.

FIG. 6A illustrates a perspective view of the decking system shown in FIG. 5A.

FIG. 6B illustrates a cross-sectional view of a portion of a decking system in accordance with one embodiment of the present invention.

FIG. 6C illustrates a cross-sectional view of a portion of a decking system in accordance with one embodiment of the present invention.

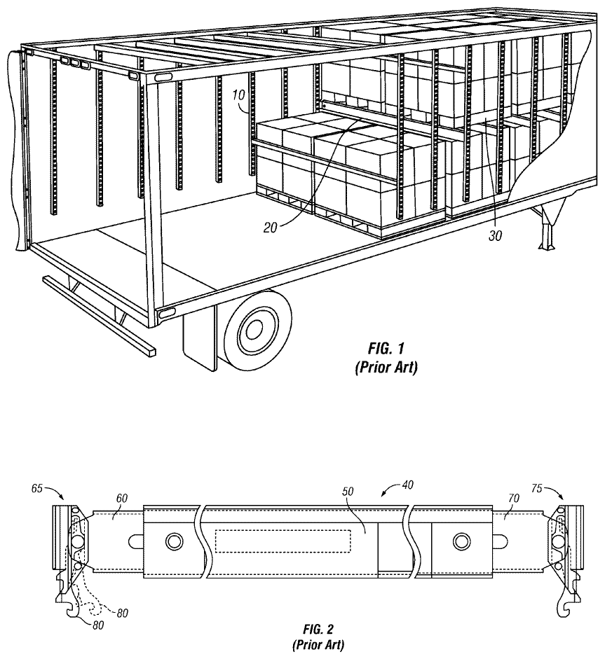

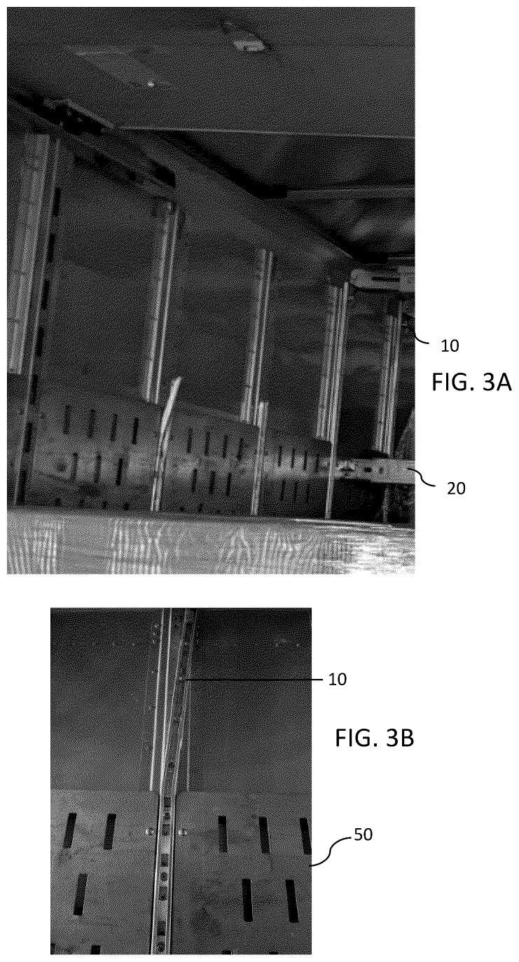

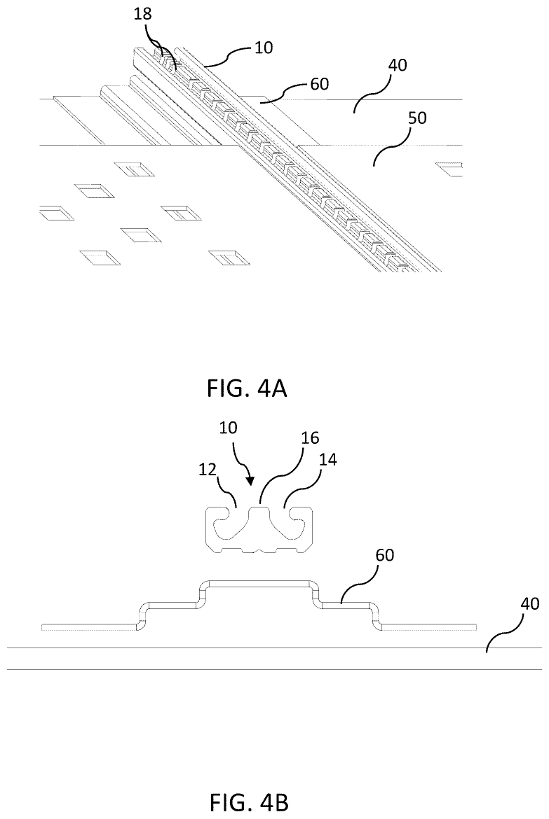

### DETAILED DESCRIPTION

The present disclosure describes aspects of the present invention with reference to the exemplary embodiments illustrated in the drawings; however, aspects of the present invention are not limited to the exemplary embodiments illustrated in the drawings. It will be apparent to those of ordinary skill in the art that aspects of the present invention include many more embodiments. Accordingly, aspects of the present invention are not to be restricted in light of the exemplary embodiments illustrated in the drawings. It will also be apparent to those of ordinary skill in the art that variations and modifications can be made without departing from the true scope of the present disclosure. For example, in some instances, one or more features disclosed in connection with one embodiment can be used alone or in combination with one or more features of one or more other embodiments.

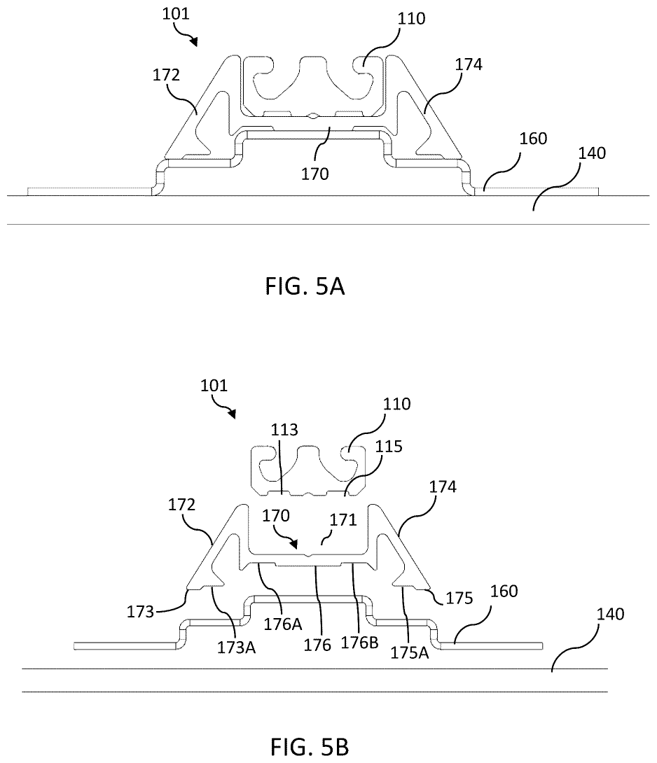

Referring first to FIGS. 5A and 5B, a track assembly 101 in accordance with the present invention is shown. The track assembly 101 comprises a track 110 and an innovative spacer 170 configured for mounting to a post 160 of a cargo container. The post 160 may be connected to container panels on its opposing side. The track assembly 101 provides enhanced impact resistance against loading forces encountered during cargo container operations. The innovative design enables simplified installation procedures that result in more uniform assembly, ensuring smooth translation of footings relative to the track throughout the product lifecycle. Compared to prior art configurations lacking a spacer 170, the track assembly 101 achieves superior force distribution characteristics.

The track 110 extends along a linear axis from a first end to a second end and is configured for vertical mounting within the cargo space. The track 110 includes a first groove 112 and a second groove 114, each extending longitudinally along the track. These grooves 112, 114 are configured to receive corresponding elements of a beam foot, enabling the foot and its associated beam to translate vertically along the track's axis. The foot can be selectively locked into position at various heights, thereby providing adjustable cargo support throughout the cargo space. A person of ordinary skill in the art, upon review of this disclosure, will understand that the present invention may be employed with various track and foot configurations beyond the specific embodiment illustrated in the figures.

The spacer 170 represents a key innovation of the present invention, fundamentally altering the interface between the track and the cargo structure. The spacer 170 includes a central recess 171 specifically dimensioned to receive and retain the track 110. This recess 171 ensures precise alignment while providing protective surrounding for the track 110. The recess 171 defines a width along the spacer's length that is slightly wider than the maximum width of the track 110. The recess has an opening defined by a first edge and a second edge. Additionally, the recess 171 defines a depth substantially corresponding to the track's height in the plane perpendicular to its axis. When assembled, the track 110 seats within the recess 171 such that the track's outer or top surface is flush with the top surface of the spacer 170. Furthermore, this nested configuration between the recess 171 and track 110 enhances the structural rigidity of the track's mounting relative to the post 160.

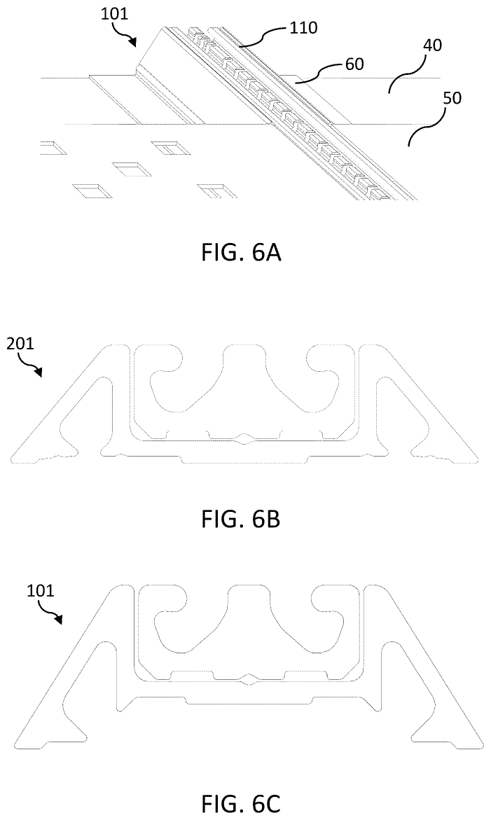

The assembly 101 represents an innovation over the prior art through its incorporation of a spacer 170 between the track 110 and the post 160. While the prior art universally employed direct track-to-post mounting using rivets, the present invention introduces the intermediate spacer 170 positioned between the track 110 and post 160, as illustrated in the figures. In the disclosed embodiment, the spacer 170 extends continuously from the first end of the track 110 to its second end, such that the spacer 170 is disposed between the track 110 and the post 160 along their entire lengths. A person of ordinary skill in the art, upon review of this disclosure, will understand that the invention encompasses variations where the spacer may be disposed between the track 110 and post 160 along only a portion of their lengths. For example, in some embodiments, the spacer 170 may be disposed between the track 110 and post 160 only along the portion of the track 110 above the floor spacer 150 in the cargo container, as illustrated in FIG. 6A. In other embodiments, the spacer 170 may extend for only select portions of the track length above the floor spacer.

The spacer 170 defines first and second sides 172, 174. These sides extend outward and downward from the top opening of the central recess 171. In the illustrated embodiment, the first side 172 extends at an angle of approximately 60 degrees relative to the panel 140 when the track assembly 101 is installed. Approximately means plus or minus five degrees. Similarly, the second side 174 extends at an angle of approximately 60 degrees relative to the panel 140. This angular configuration results in the spacer 170 having its narrowest cross-sectional width at its outermost portion, progressively widening from top to base, as illustrated in FIGS. 5A and 5B. While angles of approximately 60 degrees are preferred in this embodiment based on testing and analysis, different angles may be employed for either or both sides 172, 174 while maintaining the deflective and protective benefits of the angled configuration.

The angled first and second sides 172, 174 effectively deflect impacts away from the track 110, converting direct forces into glancing blows. In prior art configurations, the outer surface of the track was substantially perpendicular to the panel, resulting in the full force of any impact being transferred directly to the track. When subjected to misaligned loading from equipment such as forklifts or pallet jacks, this perpendicular configuration would generate significant shearing forces at the point of impact. The present invention overcomes this limitation through its angled surfaces relative to the vertical plane. This angular configuration converts errant loading forces into downward components, thereby reducing the lateral forces that would typically be exerted against a perpendicular track. Furthermore, the angled sides provide the additional benefit of deflecting loading forces away from both the track and panel, potentially redirecting errant loads toward the center of the cargo container during delivery operations.

While the first and second sides 172, 174 may share similar angles, a person of ordinary skill in the art will understand that the angles of both sides relative to the panel 140 may vary independently without departing from the scope of the invention. In some embodiments, one or both sides may be configured to extend substantially perpendicular to the plane of the panel. Although such a perpendicular configuration may reduce the deflection functionality, the spacer 170 continues to provide protection by serving as a protective sleeve or casing for the track 110. Moreover, regardless of the side angle configuration, the spacer 170 maintains its secondary function of providing an optimized interface between the track 110 and post 160, enabling secure adhesive bonding through the recesses 173A, 175A, 176A, and 176B.

The angle of the first side 172 and second side 174 relative to the panel may vary within a range of approximately 10 to 90 degrees. In one embodiment, the angle is between 40 degrees and 80 degrees relative to the panel. In a preferred embodiment, the angle is between 50 degrees and 70 degrees, with approximately 60 degrees being most preferred due to optimal force deflection characteristics while maintaining a minimal footprint. A person of ordinary skill in the art will understand that angles less than 30 degrees may reduce material requirements but may also compromise deflection effectiveness, while angles greater than 80 degrees may increase material usage while providing diminishing returns in impact protection. The specific angle selection may be determined based on various factors including, but not limited to: installation environment requirements, manufacturing considerations, material selection, and cost constraints. In some embodiments, the first side 172 and second side 174 may be configured with different angles relative to the panel, enabling optimization based on anticipated impact directions or specific space constraints within the cargo container.

The angled surfaces serve multiple functional purposes in the assembly. Their primary function is to deflect impacts away from the track 110, converting direct impact forces into glancing blows that substantially reduce stress on the assembly. While testing has demonstrated particularly effective results at approximately 60 degrees from vertical, the invention encompasses various angles that achieve the desired deflection characteristics. The specific angle selection may be optimized for particular applications while remaining within the scope of the invention, provided the chosen configuration maintains effective impact force redistribution.

During normal cargo container operations, the track 110 encounters frequent impact forces during loading and unloading procedures. These forces typically occur when cargo handling equipment, such as forklifts or pallet jacks, or the cargo itself, contacts the track assembly 101. Without adequate protection, such impacts can compromise the track's structural integrity, potentially affecting its ability to securely engage with beam feet or necessitating costly replacement. The angled first side 172 and second side 174 of spacer 170 function as deflection elements, effectively redirecting these impact forces. When cargo or equipment contacts these angled surfaces, the geometric configuration converts direct impact forces into glancing blows, substantially reducing potential track damage. This deflection mechanism proves particularly effective against side impacts, which commonly occur during cargo positioning operations. Thus, the spacer 170 serves as a protective barrier that extends the operational lifespan of the track 110 while maintaining the functional integrity of the cargo container's decking system.

The spacer 170 includes extended feet 173, 175 at the lower ends of the angled sides 172, 174 respectively. These feet are specifically engineered to provide stable mounting surfaces. The feet 173, 175 incorporate precisely formed recesses 173A, 175A configured to receive double-sided adhesive tape for secure mounting.

The spacer 170 includes additional recesses 176A and 176B on its bottom surface 176, establishing a multi-point mounting system. These recesses work in conjunction with recesses 173A, 175A to provide optimal tape placement for maximum adhesion and force distribution. The strategic positioning of these recesses ensures consistent contact pressure across all mounting surfaces, enhancing overall assembly stability.

The post 160, which serves as the mounting structure for the assembly, includes a top section 166 and side sections 163, 165. This post configuration represents a standard element in sheet and post trailer construction, where the post provides primary structural support. The spacer 170 incorporates a bottom profile 176 specifically designed to accommodate these common post configurations while maintaining consistent mounting geometry for the track 110.

In one embodiment, high-strength industrial adhesive tape, such as 3M GHB tape, is applied within all recesses (173A, 175A, 176A). This tape functions as the primary mounting medium, offering several advantages over traditional direct mounting methods. The tape creates a continuous bond along the spacer's length, enabling force distribution across a larger surface area rather than concentrating forces at discrete points. While 3M GHB tape is disclosed in this embodiment, the invention encompasses the use of any suitable tape capable of providing secure component fixation, including but not limited to: VHB tapes, foam-core tapes, acrylic-based tapes, butyl tapes, aluminum foil tapes, reinforced filament tapes, and high-strength mounting tapes.

In the disclosed embodiment, the track 110 incorporates recesses 113 and 115 formed in its bottom surface 117. These recesses are specifically configured for receiving double-sided adhesive tape, establishing a secure connection between the track's bottom surface and the bottom of recess 171 in spacer 170. Similarly, the spacer 170 includes recesses 173A, 175A, 176A, 176B configured for adhesive tape mounting to the post 160. This multi-point adhesive mounting system creates a distributed connection between components, effectively dispersing forces along the assembly's length rather than concentrating them at discrete points. While this adhesive mounting system can eliminate traditional rivets and washers, certain embodiments may combine adhesive tape with selective rivet placement to provide redundant connection points. This hybrid approach optimizes force distribution while maintaining the ability to comply with specific installation requirements or local regulations.

The adhesive mounting system described herein does not require continuous tape application along the entire length of track 110 or spacer 170. Instead, adhesive placement may be strategically implemented in sections or zones to provide adequate mounting force while optimizing material usage and installation efficiency. For example, adhesive may be applied in predetermined length strips, spaced at regular intervals within recesses 113, 115, 173A, 175A, 176A, and 176B. The specific pattern and spacing of adhesive application may be determined by factors including: anticipated load conditions, local installation requirements, and overall assembly length. Testing has shown that adhesive sections of approximately 4 to 12 inches in length, spaced approximately 12 to 36 inches apart, provide suitable mounting strength while enabling efficient material usage. This sectional application approach maintains force-distribution benefits while reducing material costs and simplifying installation procedures. Additionally, the spacing between adhesive sections facilitates moisture drainage and prevents water trap points, enhancing the assembly's long-term durability.

In one embodiment, high-strength industrial adhesive tape, such as 3M GHB tape, is applied within all recesses (173A, 175A, 176A, 176B, 113 and 115). This tape serves as the primary mounting medium, providing several advantages over traditional direct mounting methods. The tape creates a continuous bond along the spacer's length, enabling force distribution over a larger area rather than concentrating forces at discrete points. While 3M GHB tape is disclosed, the invention encompasses any suitable tape capable of providing secure component fixation, including but not limited to: VHB tapes, foam-core tapes, acrylic-based tapes, butyl tapes, aluminum foil tapes, reinforced filament tapes, and high-strength mounting tapes.

While adhesive tape is disclosed as the mounting medium, the present invention is not limited to tape-based adhesive applications. Alternative adhesive application methods may be employed, including but not limited to: liquid adhesives, hot-melt adhesives, pressure-sensitive adhesives in non-tape form, structural adhesives, two-component adhesives, UV-curable adhesives, moisture-curing adhesives, and dispensable adhesive materials. These alternative adhesive systems may be applied through various methods such as dispensing guns, automated application systems, spray systems, or manual application processes. Regardless of the specific adhesive type or application method chosen, the adhesive should be selected and applied to provide secure bonding between components while maintaining the force distribution and impact resistance benefits described herein. The recesses described for tape mounting may be modified or adapted to accommodate different adhesive types and application methods while maintaining their function of optimizing adhesive placement and performance.

While specific recesses 173A, 175A, 176A, and 176B are illustrated in the figures, the present invention contemplates various configurations of recesses for receiving adhesive or tape. Any suitable adhesive type may be used in any recess, and some embodiments may include additional recesses, fewer recesses, or even no recesses while still maintaining mounting capability. In one embodiment, high-strength structural adhesive is employed in recesses 173A and 175A, while adhesive tape is utilized in recesses 176, 176A, and 176B. The number, placement, and configuration of recesses may vary from the illustrated embodiment without departing from the scope of the invention while maintaining the functional benefits of the mounting system described herein.

The elimination of traditional fixation methods, namely riveting and washer shimming, provides multiple benefits. Installation time is significantly reduced by eliminating the need to position and hold multiple washers during track mounting. The spacer 170 automatically provides consistent spacing and alignment, improving installation accuracy and reducing error potential. Furthermore, the tape connection provides uniform retaining force along the entire fixation length, contrasting with the discrete point forces at rivet locations. Consequently, the connection between track 110, spacer 170, and post 160 achieves more uniform force distribution throughout the system 101.

Referring to FIG. 6A, a first variation of the spacer profile is shown, specifically adapted for a common trailer post configuration. This embodiment demonstrates how the invention's fundamental principles can be adapted to various post geometries while maintaining all functional benefits.

FIGS. 6B and 6C illustrate additional spacer profile variations, each optimized for different trailer post configurations. These variations maintain core functional elements—angled sides for impact deflection, recesses for tape mounting, and proper track positioning—while adapting mounting surfaces to match specific post geometries.

The inventor has discovered that the angled surfaces 172, 174 provide crucial impact protection through multiple mechanisms. First, the angles convert direct impacts into glancing blows, redirecting force away from the track assembly. Second, the geometry enables controlled deflection under impact, absorbing energy while maintaining structural integrity.

Another advantage of the present invention is enhanced force distribution through the continuous nature of spacer 170. Impact forces spread along the assembly's length rather than concentrating at mounting points. The adhesive tape in recesses 173A, 175A, and 176A provides additional force dampening, helping isolate track 110 from sudden impacts.

The spacer 170 maintains consistent performance across varying temperatures, addressing a crucial advantage in transportation applications typically subject to large temperature variations. Traditional systems combining steel rivets with aluminum tracks and posts experience varying rates of thermal expansion and contraction, resulting in track unevenness and deformation. The tape fixation method significantly improves the assembly by minimizing expansion and contraction issues that affect traditional mounting systems, ensuring reliable operation across all weather conditions.

The profile design enables efficient material usage while maintaining necessary strength. In a preferred embodiment, the spacer 170 is manufactured through aluminum extrusion, providing optimal balance of weight, strength, and cost. However, the design equally accommodates manufacture through folded metal techniques, offering production method flexibility.

The spacer 170 can be produced in various lengths, enabling optimization based on specific installation requirements. Shorter sections may be employed in areas requiring additional flexibility, while longer sections provide maximum efficiency in standard installations.

Maintenance and repair procedures are significantly simplified compared to prior art systems. Damaged sections can be replaced without extensive disassembly or specialized tools. The robust mounting system enables sectional replacement while maintaining system integrity.

The system demonstrates particular effectiveness in high-use environments where impacts frequently occur. The combination of deflective geometry and distributed mounting forces substantially reduces the likelihood of damage to both track 110 and underlying post 160.

Testing demonstrates superior durability of the assembly compared to traditional mounting methods. The angled surfaces 172, 174 effectively redirect impacts, while the tape mounting system absorbs and distributes forces that would typically cause damage to rigidly mounted tracks.

The spacer 170 eliminates sharp edges or corners that could snag cargo or cause injury during loading operations. All transitions incorporate smooth radii, enhancing both operational safety and structural durability.

While the illustrated embodiments show specific angles and dimensions, these parameters may be modified to suit particular applications without departing from the invention's scope. The core principles of impact deflection and force distribution remain consistent across various geometric configurations.

The system maintains compatibility with all standard cargo beam types and locking mechanisms. The track grooves 112, 114 retain industry-standard dimensions and spacing, ensuring universal compatibility while providing enhanced protection and mounting stability.

The recesses 173A, 175A, and 176A incorporate precise dimensions to optimize tape placement and performance. The recess depth ensures proper tape compression when mounted, while the width maximizes adhesive surface area. This engineered precision in mounting interfaces significantly contributes to overall system performance.

Beyond primary mounting locations, the spacer 170 may incorporate supplementary features such as alignment guides or installation markers. While not illustrated in the figures, these features can further simplify installation procedures and ensure proper positioning relative to post 160.

The structural interface between spacer 170 and post 160 creates a system that effectively manages both static and dynamic loads. During normal operation, the distributed mounting through tape in recesses 173A, 175A, and 176A provides stable support. Under impact conditions, these mounting points work in concert with angled surfaces 172, 174 to absorb and redistribute forces that would typically damage traditional mounting systems.

The spacing provided by the profile geometry serves multiple functions beyond simple offset. The air gap created between certain surfaces prevents moisture accumulation, while the overall geometry ensures proper track 110 alignment regardless of minor post configuration variations. This self-aligning feature substantially reduces installation complexity compared to traditional shimming methods.

Heat dissipation and thermal management benefit from the spacer design. The profile geometry and material selection accommodate proper thermal expansion without compromising mounting integrity. Unlike traditional direct-mount systems where thermal cycles stress mounting points, the present invention accommodates thermal movement while maintaining structural stability.

The profile's cross-section maintains consistent properties along its length, enabling continuous extrusion manufacturing processes. This consistency, combined with variable length cutting capability, provides manufacturing flexibility while ensuring uniform performance characteristics throughout each installation.

Load transfer through the assembly follows predictable paths, with forces distributing across multiple contact surfaces rather than concentrating at discrete points. The angled surfaces 172, 174 play a crucial role in force distribution, converting direct impacts into components more effectively managed by the mounting system.

Material selection for spacer 170 balances multiple requirements. When manufactured from aluminum extrusion, the profile maintains high strength-to-weight characteristics while providing excellent corrosion resistance. Alternative manufacturing through folded metal techniques enables cost optimization for specific applications while preserving essential geometric features that provide impact protection and force distribution.

Field replacement procedures benefit from the assembly's modular nature. Damaged sections can be removed by first extracting any affected track section rivets (where rivets are employed), then carefully separating the spacer 170 from its mounting surfaces. New sections can be prepared using fresh adhesive tape in recesses 173A, 175A, 176A, 176B, 113, and 114, then installed following standard mounting procedures.

The tape mounting system serves multiple functions beyond adhesion. The viscoelastic properties of the specified tape provide vibration dampening, while its distributed nature ensures consistent load sharing across the mounting interface. The recesses protect tape edges while ensuring proper compression during installation.

The dimensional stability of spacer 170 ensures track 110 maintains proper alignment throughout all operating conditions. Unlike traditional mounting methods where thermal cycling can progressively loosen mechanical fasteners, the combination of adhesive mounting and mechanical retention maintains consistent positioning even under severe environmental variations.

The system's response to dynamic loading addresses both sudden impacts and cyclic fatigue conditions. Under impact loading, the angled surfaces 172, 174 provide immediate force deflection, while the distributed mounting through recesses prevents concentration of reaction forces that could damage either track 110 or post 160.

Integration with existing trailer manufacturing processes has been carefully considered. The spacing provided by spacer 170 accommodates standard rivet lengths and installation tools, while the tape mounting system eliminates special installation equipment requirements. This compatibility with existing manufacturing infrastructure minimizes implementation costs.

The present disclosure describes aspects of the invention with reference to the exemplary embodiments illustrated in the drawings; however, the invention's scope extends beyond these illustrated embodiments. Those skilled in the art will recognize that the invention encompasses numerous additional embodiments not explicitly shown in the drawings. Accordingly, the invention should not be restricted to the exemplary embodiments illustrated. Those skilled in the art will further recognize that variations and modifications are possible without departing from the true scope of the present disclosure. Features disclosed in connection with any embodiment may be used alone or in combination with features of other embodiments.

What is claimed is:

1. A spacer for use in an adjustable decking system in a cargo container, the adjustable decking system having a track configured to receive an adjustable beam translatable along the track, the adjustable decking system further including a post, the track being fixed relative to the post, the spacer being positioned between the track and the post, the spacer comprising:
a body extending along a linear axis;
a recess formed in the body and extending along the linear axis, the recess having an opening configured to receive at least a portion of the track;
a first mounting surface defining a bottom of the recess and extending along the linear axis; and
a second mounting surface;
wherein the body is configured to be disposed between the track and the post such that the track is fixed to the first mounting surface and the post is fixed to the second mounting surface.

2. The spacer of claim 1, wherein the body includes a first side extending from the opening at a first angle relative to the first mounting surface.

3. The spacer of claim 2, wherein the first angle is between 40 degrees and 80 degrees relative to the first mounting surface.

4. The spacer of claim 2, wherein the body further includes a second side extending from the open of the central recess at a second angle relative to the first mounting surface.

5. The spacer of claim 4, wherein the first angle and the second angle are each 60 degrees relative to the first mounting surface.

6. The spacer of claim 1, wherein the first mounting surface includes at least one recess configured to receive adhesive tape.

7. The spacer of claim 6, wherein the body includes a plurality of recesses configured to receive adhesive tape, the plurality of recesses including:
at least one recess the second mounting surface of the body; and
at least one recess on a side surface of the body.

8. The spacer of claim 1, wherein first mounting surface includes at least one recess configured to receive adhesive tape for fixing said track to the spacer.

9. The spacer of claim 8, wherein the first mounting surface includes a first tape recess and a second tape recess configured to secure said track within said central recess.

10. An adjustable decking system in a cargo container, comprising:
a track configured to receive an adjustable beam translatable along the track;
a post, the track being fixed relative to the post; and
a spacer positioned between the track and the post, the spacer comprising:
a body extending along a linear axis;
a recess formed in the body and extending along the linear axis, the recess having an opening configured to receive at least a portion of the track;
a first mounting surface defining a bottom of the recess and extending along the linear axis; and
a second mounting surface;
wherein the spacer is disposed between the track and the post such that the track abuts the first mounting surface and the post abuts the second mounting surface.

11. The system of claim 10, wherein the track is fixed to the first mounting surface by a first adhesive tape and the spacer is fixed to the post by a second adhesive tape.

12. The system of claim 11, wherein the body includes a first side extending from the opening at a first angle relative to the first mounting surface.

13. The system of claim 10, wherein the body includes a first side extending from the opening at a first angle relative to the first mounting surface.

14. The system of claim 13, wherein the first angle is between 40 degrees and 80 degrees relative to the first mounting surface.

15. The system of claim 13, wherein the body further includes a second side extending from the opening of the recess at a second angle relative to the first mounting surface.

16. The system of claim 15, wherein the first angle and the second angle are each approximately 60 degrees relative to the first mounting surface.

17. The system of claim 10, wherein the first mounting surface includes at least one recess configured to receive adhesive tape.

18. The system of claim 17, wherein the body includes a plurality of recesses configured to receive adhesive tape, the plurality of recesses including:
at least one recess on the second mounting surface of the body; and
at least one recess on a side surface of the body.

19. The system of claim 10, wherein the first mounting surface includes at least one recess configured to receive adhesive tape for securing the track to the spacer.

20. The system of claim 19, wherein the first mounting surface includes a first tape recess and a second tape recess configured to secure the track within the central recess.
